(19) United States
(12) Patent Application Publication
(10) Pub. No.: US 2003/0060567 A1
(43) Pub. Date: Mar. 27, 2003

(54) Polyalkylene polysulphides

(76) Inventors: Juergen Faderl, Ilvesheim (DE); Hans-Josef Sterzel, Dannstadt-Schauernheim (DE)

Correspondence Address: Keil & Weinkauf, 1101 Connecticut Avenue NW, Washington, DC, 20036, US

(21) Appl. No.: 10/203,283

(22) PCT Filed: Feb. 14, 2001
(86) PCT No.: PCT/EP01/01631

(30) Foreign Application Priority Data
Feb. 15, 2000 (DE) 100 06 546.5
Mar. 27, 2000 (DE) 100 15 176.0
Jul. 19, 2000 (DE) 100 350 77.1

(51) Int. Cl. C08L 7/00; C08K 5/07

(52) U.S. Cl. 525/154; 528/226

(57) ABSTRACT

Polyalkylene polysulfides, comprising chains of the formula I

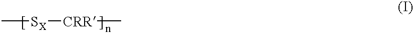

R and R′ are identical or different and are hydrogen or alkyl having from 1 to 4 carbon atoms or COR″, where

R″ is hydrogen or alkyl having from 1 to 4 carbon atoms,

x is a number whose average is from 2 to 20, and

n is a number>10.

A process is moreover disclosed for preparing polyalkylene polysulfides by reacting at least one carbonyl compound of the formula II

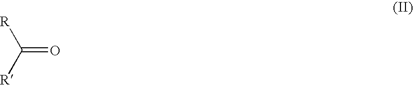

R and R′ are as defined above,

with sulfur and hydrogen sulfide in the presence of a basic catalyst.

The invention relates to polyalkylene polysulfides, a process for their preparation, their use, rubber compositions comprising the same, the use of these, vulcanizers comprising the polyalkylene polysulfides, certain molding compositions comprising the polyalkylene polysulfides, moldings produced from these, a process for producing the moldings, and also the use of these molding compositions.

Polysulfide rubbers are mainly used as sealing materials. Solid grades here can be processed to give sealing rings, while liquid grades serve as jointing compositions, for example. As described in DE-A 675 401, for example, polysulfide rubbers are usually prepared from alkali metal polysulfides, ammonium polysulfides or alkaline earth metal polysulfides and alkylene dichlorides via salt-elimination reactions. A disadvantage is the enormous amount of salt produced in this preparation process.

U.S. Pat. No. 2,206,641 describes a process for preparing methylene polysulfide, in which methylene chloride is reacted with Na₂S₂ in aqueous solution.

When unvulcanized rubber mixtures to which S₈ sulfur has been added as vulcanizer in amounts above the solubility limit are stored for a prolonged period, S₈ sulfur, which has poor solubility in rubber at normal storage temperatures, crystallizes out on the surface of the rubber mixtures. To prevent the occurrence of this effect, termed “bleed-out”, polymeric μ sulfur is generally used as vulcanizer instead of S₈ sulfur by the rubber industry. However, μ sulfur is not stable over long periods and, even at room temperature, decomposes on storage to give S₈ sulfur.

To counter these storage problems, a number of experiments have attempted to develop vulcanizers based on sulfur copolymers. These are copolymers with olefins or olefin mixtures, in particular with dicyclopentadiene and styrene. Vulcanizers of this type, which are obtained by reacting sulfur with an olefin at from 140 to 160° C. in the presence of a basic catalyst, are disclosed in U.S. Pat. Nos. 4,739,036, 4,740,559 and 2,989,513.

The products obtained as in the abovementioned publications have properties intermediate between those of polymeric sulfur and S₈ sulfur and do not therefore represent any improvement over polymeric sulfur. In particular, they comprise a high proportion of soluble S₈ sulfur, which causes the bleed-out behavior to be poorer than with μ sulfur.

It is an object of the present invention to find a process which prepares polysulfide rubbers and avoids the production of salts which is otherwise customary. A further object of the invention is to provide vulcanizers based on sulfur copolymers with good bleed-out behavior, for vulcanizing rubber mixtures.

We have found that this object is achieved by using polyalkylene polysulfides containing chains of the formula I

[[Sₓ—CRR′]]ₙ (I)

where

R and R′ are identical or different and are hydrogen or alkyl having from 1 to 4 carbon atoms or COR″, where

R″ is hydrogen or alkyl having from 1 to 4 carbon atoms,

x is a number whose average is from 2 to 20, and

n is a number >10.

The polyalkylene polysulfides of the invention contain chains of the formula I and preferably consist essentially of chains of the formula I. Polyalkylene polysulfides consisting essentially of chains of the formula I are those which very predominantly, for example to an extent of at least 90%, and preferably exclusively, have repeat units of the formula Ia

[[S_{x′}—CRR′]] (Ia)

where x′ is an integer whose value can vary from repeat unit to repeat unit and whose average value is x. The polyalkylene polysulfides of the invention also have end groups. End groups which may be present include SH, OH and H.

R and R′ are identical or different and are hydrogen, alkyl having from 1 to 4 carbon atoms, such as methyl, ethyl, n-butyl, isobutyl, sec-butyl or tert-butyl, or COR″, where R″ is hydrogen or one of the abovementioned alkyl groups.

x is a number whose average is from 2 to 20, preferably from 2 to 5, particularly preferably about 4, and n is a number >10. The polyalkylene polysulfides of the invention may have low molecular weight or high molecular weight. Examples of low-molecular-weight polyalkylene polysulfides are those having n=from 10 to 50, and examples of high-molecular-weight polyalkylene polysulfides are those having n>50. The distribution of x is preferably narrow, i.e. in a polyalkylene polysulfide in which x is a number whose average is 4, for example, x′ is 4 in >80% of the repeat units of the formula Ia and is 3 or, respectively, 5 in <20% of the repeat units Ia.

All of the radicals R and R′ may be identical, or they may vary within the chain. It is preferable for all of the radicals R and R′ to be identical.

The polyalkylene polysulfides of the invention may be prepared by copolymerizing carbonyl compounds with elemental sulfur and hydrogen sulfide in the presence of a basic catalyst. The present invention therefore also provides a process for preparing polyalkylene polysulfides by reacting at least one carbonyl compound of the formula II

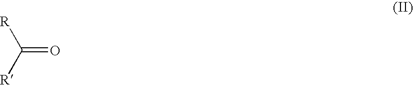

where

R and R′ are as defined above,

with sulfur and hydrogen sulfide in the presence of a basic catalyst according to the equation:

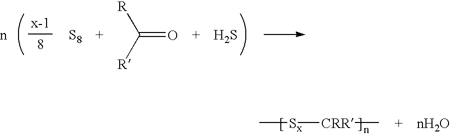

Suitable carbonyl compounds are aldehydes R—CHO, where R is preferably H, CH₃, C₂H₅, n- or iso-C₃H₇, or n-, iso-, sec- or tert-C₄H₉. Other suitable carbonyl compounds are ketones R—CO—R′, where R and R′ may be identical or different and are preferably CH₃, C₂H₅, or n- or iso-C₃H₇. Other suitable carbonyl compounds are glyoxals R—CO—CO—R″, where R and R″ may be identical or different and are preferably H, CH₃, C₂H₅, or n- or iso-C₃H₇.

Particularly preferred carbonyl compounds are formaldehyde, in particular in the form of a formalin solution, and acetaldehyde.

One carbonyl compound of the formula II or a mixture of two or more different carbonyl compounds of the formula II may be reacted. It is preferable to react just one carbonyl compound.

The value of x may be set by selecting the molar ratio carbonyl compounds:elemental sulfur. Said molar ratio is generally from 1:1 to 1:19, preferably from 1:2 to 1:6 and particularly preferably about 1:3, based on sulfur atoms. For example, a molar ratio of about 1:3 gives polyalkylene polysulfides where the average of x is about 4. The stoichiometry of the reaction is such that x−1 sulfur atoms come from the elemental (S₈) sulfur and one sulfur atom comes from H₂S.

The reaction is carried out in the presence of a basic catalyst. Preferred basic catalysts are those having a sulfidic sulfur atom, for example alkali metal sulfides, alkaline earth metal sulfides or ammonium sulfides, or the corresponding hydrogensulfides or the corresponding polysulfides, and particular preference is given to Na₂S, NaHS and (NH₄)HS. Use may also be made of ammonia, amines and hydroxyl compounds, for example NH₃, NBu₃ or NaOH, and in cases where the latter non-sulfidic bases are used, sulfidic compounds are formed by reaction with H₂S.

The process is preferably carried out in an aqueous medium, generally at from 117 to 160° C., preferably from 120 to 140° C., particularly preferably from 122 to 132° C.

In one embodiment of the process of the invention, the carbonyl compound or an aqueous solution of the carbonyl compound, together with elemental sulfur and the basic catalyst, forms an initial charge in an autoclave, and the mixture is heated to the abovementioned temperatures, melting the sulfur. Hydrogen sulfide is then introduced under pressure, the gauge pressure used being 3 bar, for example. The process may, but need not, be carried out with hydrogen sulfide at above atmospheric pressure, and is preferably carried out in this manner. The absorption of hydrogen sulfide usually ceases spontaneously when the stoichiometric amount has been reached, i.e. one mol of hydrogen sulfide per mole of carbonyl compound.

If the carbonyl compound is used in the form of its aqueous solution, there is generally an aqueous phase as well as the organic product phase. Examples of methods for separating the aqueous phase off from the organic phase are removal by decanting or removal using a phase separator. It is also possible for the aqueous phase, where appropriate together with other volatile constituents, to be removed from the organic product phase by distillation. The process of the invention may be carried out batchwise or continuously. It is preferably carried out continuously using a stirred-tank cascade, the aqueous phase being removed by distillation or by use of a phase separator.

If the pure carbonyl compound is used, no removal of the aqueous phase is necessary.

To purify the product obtained, unreacted sulfur and byproducts, such as small carbon-sulfur rings, may be removed by extraction with organic solvents which dissolve sulfur, for example CS₂, CHCl₃ or CH₂Cl₂.

The present invention also provides polyalkylene polysulfides which can be prepared by one of the preparation methods described above.

The polyalkylene polysulfides of the invention have a melt viscosity, extrapolated to a shear rate of 0s⁻¹, of from 1 to 10⁴ Pa s, preferably from 5 to 1000 Pa s.

The polyalkylene polysulfides of the invention may be used in a very wide variety of application sectors, depending on whether they are low-molecular-weight or high-molecular-weight materials, whether these are used unvulcanized or vulcanized, and whether they comprise other fillers which have a reinforcing effect and raise the softening point.

The present invention also provides the use of the polyalkylene polysulfides for preparing vulcanizers, sealing materials, coating materials, impression materials, for adhesives, or producing cable insulation, or else for preparing molding compositions for the manufacture of rubber items or films.

The polyalkylene polysulfides have different levels of tack. They may be converted into dry, free-flowing powders or pellets by incorporating fillers. The polyalkylene polysulfides of the invention may be vulcanized by adding crosslinkers, such as ZnO, activated MnO₂, perborates or peroxides, or crosslinked by reaction with isocyanates, epoxides or compounds containing double bonds. They then lose their thermoplastic properties.

Low-molecular-weight polyalkylene polysulfides are workable at room temperature, and may be applied as sealing material or corrosion inhibitor to surfaces such as concrete, artificial stone, natural stone or metal, by spreading, doctoring or spraying. If vulcanizers are admixed shortly prior to working the materials, the coherent layers applied become crosslinked and thus dimensionally stable. High-molecular-weight polyalkylene polysulfides can be extruded at from 20 to 120° C., for example, to give profiles or ribbons, and they may be blended here with reinforcing fillers. They may then be extruded through flat-film dies to give films of thickness from 1 to 20 mm, for example, and these again may be used as sealing materials.

If the tack of the polyalkylene polysulfides of the invention is to be utilized, for example for sealing panes of glass or sealing windows comprising sealed glass units, it is preferable to dispense with the use of reinforcing fillers.

The polyalkylene polysulfides of the invention are resistant to chemicals and oils and do not swell and are therefore suitable in particular for the coating of reactor apparatus, chemicals containers, valves or pipelines. Unvulcanized polyalkylene polysulfides of the invention exhibit cold flow under mechanical pressure. This effect combined with their excellent sealing action with respect to water can be utilized by using flat troughs filled with the polyalkylene polysulfides of the invention and placed on the underlying ground to distribute the enormous pressure generated by structures such as houses, bridges, chimney stacks, etc. In this way the entire area is utilized, since the polyalkylene polysulfides fill any cavity and also provide excellent compensation for thermal expansion.

The polyalkylene polysulfides of the invention may be processed to give any type of fusible sealing tapes or fusible sealing films, suitable for providing impermeability for buildings, roads, substructures, tunnel structures, tank sumps, duct structures, swimming pools, landfill sites, boats or aircraft tanks.

The polyalkylene polysulfides of the invention may also be used, alone or in combination with other compounds, as molding compositions or adhesives. They can also be used to manufacture cable insulation or impression materials, for example impression materials for technical or dental use.

The polyalkylene polysulfides of the invention are moreover particularly suitable as non-bleeding vulcanizers for the manufacture of rubber items. Those particularly suitable for this purpose have a high sulfur content, such as from 85 to 95% by weight of sulfur.

The polyalkylene polysulfides of the invention may be mixed at from 80 to 120° C. with elastomers containing carbon-carbon double bonds, shaped at these temperatures, for example by extrusion, compression molding or calendering, and the shaped mixture crosslinked at from 140 to 200° C. without the addition of other crosslinkers. This gives solvent- and oil-resistant high-sulfur-content elastomers for a variety of applications, for example in the form of profiles, hoses, sheets or films.

The proportion by weight of the sulfur copolymers of the invention to the elastomers containing carbon-carbon double bonds is generally from 95:5 to 10:90, preferably from 90:10 to 30:70.

Examples of elastomers containing carbon-carbon double bonds and which may be used are:

natural rubber (polyisoprene) and synthetic rubber, such as polybutadiene, polychloroprene, ethylene-propylene terpolymers, nitrile rubber, styrene-butadiene rubber, synthetic polyisoprene and butyl rubber.

The present invention also provides molding compositions comprising from 10 to 95% by weight, preferably from 30 to 90% by weight, of the polyalkylene polysulfides of the invention, as component A″, and from 5 to 90% by weight, preferably from 10 to 70% by weight, of elastomers containing carbon-carbon double bonds, as component B″, the use of these molding compositions for the manufacture of moldings, such as profiles, hoses, sheets or films, a process which manufactures these moldings by blending component A″ and B″ at from 80 to 120° C., shaping the resultant molding compositions at these temperatures and crosslinking the molding compositions at from 140 to 200° C. in the absence of other crosslinkers, and moreover provides the moldings themselves manufactured from the molding compositions.

The present invention further provides polyalkylene polysulfide rubber compositions comprising

from 10 to 95% by weight of a polyalkylene polysulfide of the invention, as component A,

from 0.1 to 20% by weight of a crosslinker, as component B,

from 0.1 to 90% by weight of fillers and/or pigments, as component C,

from 0 to 50% by weight of plasticizers, as component D, and from 0 to 20% by weight of customary additives, such as adhesion promoters, agents with thixotropic effect, or accelerators, as component E.

Polyalkylene polysulfide rubber compositions of this type may be used as sealing material, coating material, impression material or as a molding composition for the manufacture of rubber items or films, or else for other applications mentioned above.

The polyalkylene polysulfide rubber compositions of the invention comprise from 10 to 95% by weight, preferably from 20 to 70% by weight, of a polyalkylene polysulfide, as component A.

The polyalkylene polysulfide rubber compositions of the invention comprise from 0.1 to 20% by weight, preferably from 1 to 15% by weight, of a crosslinker, as component B. Suitable crosslinkers are inorganic crosslinkers, such as lead dioxide, manganese dioxide, potassium permanganate, chromates, dichromates, alkali metal perborates, calcium peroxide, lithium peroxide, or zinc peroxide, and organic crosslinkers, for example hydroperoxides, such as cumene hydroperoxide, dioximes, and di- and polyisothiocyanates.

The polyalkylene sulfide rubber compositions of the invention comprise from 0.1 to 90% by weight, preferably from 1 to 50% by weight, of fillers and/or pigments, as component C. Examples of suitable fillers are fine-particle silicon dioxide, titanium dioxide, talc, calcium carbonate, kaolin and carbon black. Examples of pigments are titanium dioxide, iron oxide and carbon black.

The polyalkylene polysulfide rubber compositions of the invention may moreover comprise from 0 to 50% by weight of plasticizers, as component D. Examples of plasticizers are phthalic esters, benzyl butyl phthalate and chloroparaffins.

The polyalkylene polysulfide rubber compositions of the invention may also comprise from 0 to 20% by weight of customary additives, such as adhesion promoters, agents with thixotropic effect, accelerators, retarders or dryers, as component E.

The polyalkylene polysulfide rubber compositions of the invention may be formulated either as single-component systems or as two-component systems. For example, component 1 may comprise the polyalkylene polysulfides of the invention and the fillers, if desired alongside plasticizers and other additives, while component 2 comprises the crosslinker, if desired alongside another plasticizer and other additives, components 1 and 2 being mixed immediately prior to the use of the material.

The present invention also provides a vulcanizer comprising from 20 to 90% by weight, preferably from 40 to 55% by weight, of the polyalkylene polysulfides of the invention, as component A′, and from 10 to 80% by weight, preferably from 35 to 60% by weight, of a flow aid, reinforcing agent and/or stiffening agent, as component B′.

Adding the reinforcing agents and stiffening agents eliminates the tack of the polyalkylene polysulfides of the invention. Adding a flow aid converts these materials into an easily processable, free-flowing powder. Suitable flow aids, reinforcing agents or stiffening agents are silica, chalk, talc, kaolin and wollastonite, preferably silica.

The reinforcing agents, stiffening agents, and flow aids can be worked in using, e.g., extruders, kneading machines, blade driers, or other suitable machines. Furthermore, the products can be formulated by applying the reinforcing agents, stiffening agents, and flow aids to the surface of the product particles, the product particles being thus protected against agglutination.

The vulcanizers of the invention are used to vulcanize rubber mixtures. These vulcanizable rubber mixtures may be any rubber mixture which comprises polymers with vulcanizable multiple bonds, for example natural rubber (polyisoprene) or synthetic rubber, such as polybutadiene, polychloroprene, ethylene-propylene terpolymers, nitrile rubber, styrene-butadiene rubber, synthetic polyisoprene or butyl rubber. The vulcanizers of the invention are preferably used to vulcanize natural rubber.

In principle, it is also possible to use the polyalkylene polysulfides themselves to vulcanize the rubber mixtures.

For vulcanization, from 0.8 to 20% by weight, preferably from 2 to 6% by weight, of the novel vulcanizer is generally incorporated into the rubber mixture to be vulcanized, for example using a kneader. The rubber mixture to be vulcanized may also comprise customary auxiliaries and additives such as accelerators, retarders, antioxidants, stabilizers, fillers, adhesion promoters, plasticizers and processing aids. The vulcanization is generally carried out at from 140 to 200° C., preferably from 160 to 180° C. Basic compounds present in the vulcanizer may accelerate the vulcanization. If desired, acceleration retarders can be added to counteract this effect.

The examples below describe the invention in greater detail.

### EXAMPLES

### Example 1

576 g of sulfur, 247 g of formalin solution (36.5% by weight in water) and 30 g of Na₂S hydrate (35% by weight of Na₂S) form the initial charge in a 1.8 l autoclave and are heated to 125° C., whereupon the pressure rises to 5.2 bar. Once the sulfur has been melted, 102 g of hydrogen sulfide are introduced under pressure, the pressure not exceeding 8.0 bar. Once absorption of hydrogen sulfide has ceased, stirring is continued for a further hour. The contents of the autoclave are discharged at about 100° C., and the aqueous phase is removed once the reaction mixture has been cooled. 720 g of a solid, yellowish polysulfide are obtained.

### Example 2

481 g of sulfur, 411 g of formalin solution (36.5% by weight in water) and 7 g of NaHS form the initial charge in a 1.8 l autoclave and are heated to 125° C., whereupon the pressure rises to 4.7 bar. Once the sulfur has been melted, 147 g of hydrogen sulfide are introduced under pressure, the pressure not exceeding 8.0 bar. Once absorption of hydrogen sulfide has ceased, stirring is continued for a further hour. All of the volatile components are then distilled off at 100° C. Cooling gives 625 g of a tacky, plastic, yellow polysulfide.

### Example 3

337 g of sulfur, 155 g of acetaldehyde, 231 g of water and 8.9 g of NH₄HS (50% by weight in H₂O) form the initial charge in a 1.4 l autoclave and are heated to 125° C., whereupon the pressure rises to 6.1 bar. Once the sulfur has been melted, 112 g of hydrogen sulfide are introduced under pressure, the pressure not exceeding 9.1 bar. Once absorption of hydrogen sulfide has ceased, stirring is continued for a further hour. The contents of the autoclave are discharged at about 90° C., and the aqueous phase is removed once the reaction mixture has been cooled. 656 g of a solid, brown polysulfide are obtained.

### Example 4

512 g of sulfur, 232 g of acetone, 300 g of water and 2.9 g of Na₂S hydrate (35% by weight of sodium sulfide) form the initial charge in a 1.8 l autoclave and are heated to 125° C., whereupon the pressure rises to 4.0 bar. Once the sulfur has been melted, 138 g of hydrogen sulfide are introduced under pressure, the pressure not exceeding 8.2 bar. Once absorption of hydrogen sulfide has ceased, stirring is continued for a further hour. The contents of the autoclave are discharged at 100° C., and the aqueous phase is removed once the reaction mixture has been cooled. 768 g of a highly viscous, yellowish brown polysulfide are obtained.

### Example 5

337 g of sulfur, 255 g of isobutyraldehyde, 376 g of water and 21.3 g of Na₂S hydrate (32% by weight of sodium sulfide) form the initial charge in a 1.4 l autoclave and are heated to 125° C., whereupon the pressure rises to 4.0 bar. Once the sulfur has been melted, 120 g of hydrogen sulfide are introduced under pressure, the pressure not exceeding 7.3 bar. Once absorption of hydrogen sulfide has ceased, all of the volatile components are distilled off at from 100 to 125° C. Once the contents of the autoclave have been discharged and allowed to cool, 591 g of a yellow-brown, viscous polysulfide are obtained.

### Example 6

4 parts by weight of the tacky polysulfide from Example 2 are processed with 5 parts by weight of silica in a kneading machine, giving a free-flowing powder.

### Example 6a

6 parts by weight of the tacky polysulfide from Example 2 are processed with 4 parts by weight of silica in a blade drier, giving a free-flowing powder.

### Example 7

100 parts by weight of natural rubber (Nerub 340 p®, Weber & Schaer), 1 part by weight of stearic acid, 8 parts by weight of zinc oxide, 1.75 parts by weight of antioxidant based on aromatic amines (0.75 part by weight of Vulkanox 4010 Na and 1 part by weight of Vulkanox DDA from Bayer) and 50 parts by weight of carbon black (N330) are mixed for 4 minutes in an internal mixer. 3.6 parts by weight of the polysulfide from Example 2, 0.65 part by weight of the vulcanization accelerator thiazolylsulfenamide (Vulkacit CZ from Bayer) and 2 parts by weight of vulcanization retarder based on sulfonamides (Vulkalent E from Bayer) are then incorporated at 60° C. on a roll mill for 8 minutes. The resultant rubber mixture is used to produce test specimens, which are vulcanized at 150° C. The following measurements were made on the resultant test specimens:

TABLE 1

| Mooney scorch test DIN 53523 Part 4 | | |
|---|---|---|
| TS 5 at 100° C.: | >60 | min |
| TS 5 at 120° C.: | 18 | min |
| | 28 | sec |
| Rheometer measurements at 150° C. to | | |
| DIN 53529 Part 3 | | |
| Minimum torque: | 2.54 | dNm |
| Maximum torque: | 19.13 | dNm |
| Δ torque (dNm): | 16.53 | dNm |
| t₉₀ (minutes): | 18.37 | min |
| t at reversion 99%: | >60 | min |
| Shore A hardness to DIN 53 505: | 68.0 +/− 0.6 | |
| after aging (48 hours at 100° C.): | 73.7 +/− 0.3 | |
| S2 tensile test to DIN 53 504 | | |
| immediately after vulcanization | | |
| Tensile strength: | 27.6 +/− 0.3 | MPa |
| Elongation at break: | 496 +/− 10% | |
| Stress value 100%: | 3.4 | MPa |
| Stress value 200%: | 8.9 +/− 0.1 | MPa |
| Stress value 300%: | 15.3 +/− 0.2 | MPa |
| S2 tensile test to DIN 53 504 after aging | | |
| (48 hours at 100° C.) | | |
| Tensile strength: | 19.6 +/− 1.0 | MPa |
| Elongation at break: | 329 +/− 14% | |
| Stress value 100%: | 4.7 +/− 0.1 | MPa |
| Stress value 200%: | 11.5 +/− 0.3 | MPa |
| Stress value 300%: | 18.1 +/− 0.4 | MPa |
| Tear propagation resistance | | |
| Strip specimen to DIN 53507: | 18.4 +/− 4.0 | N/mm |
| Graves test: | 37.1 +/− 3.0 | N/mm |
| Flexometer test | | |
| Flow: | 9.2 +/− 1.1% | |
| Residual deformation: | 11.3 +/− 0.2% | |
| Temperature increase: | 25.0° | C. |

### Example 7a

100 parts by weight of natural rubber (Nerub 340 P®, Weber & Schaer), 1 part by weight of stearic acid, 8 parts by weight of zinc oxide, 1.75 parts by weight of antioxidant based on aromatic amines (0.75 part by weight of Vulkanox 4010 Na and 1 part by weight of Vulkanox DDA from Bayer) and 50 parts by weight of carbon black (N330) are mixed for 4 minutes in an internal mixer. 6.1 parts by weight of the polysulfide from Example 6a, 0.65 part by weight of the vulcanization accelerator thiazolylsulfenamide (Vulkacit CZ from Bayer) and 2 parts by weight of vulcanization retarder based on sulfonamides (Vulkalent E from Bayer) are then incorporated at 60° C. on a roll mill for 8 minutes. The resultant rubber mixture is used to produce test specimens, which are vulcanized at 150° C. The following measurements were made on the resultant test specimens:

TABLE 2

| Mooney scorch test DIN 53523 Part 4 | | |
|---|---|---|
| TS 5 at 100° C.: | >60 | min |
| TS 5 at 120° C.: | 15.9 | min |
| Rheometer measurements at 150° C. to | | |
| DIN 53529 Part 3 | | |
| Maximum torque: | 16.69 | dNm |
| t₉₀ | 19.1 | min |
| Shore A hardness to DIN 53 505: | 66.0 | |
| after aging (72 hours at 100° C.): | 71.0 | |
| S2 tensile test to DIN 53 504 | | |
| immediately after vulcanization | | |
| Tensile strength: | 19.3 | MPa |
| Elongation at break: | 400.1% | |
| S2 tensile test to DIN 53 504 after aging | | |
| (72 hours at 100° C.) | | |
| Tensile strength: | 7.5 | MPa |
| Elongation at break: | 165.7% | |
| Tear propagation resistance | | |
| Graves test: | 50.9 | N/mm |

We claim:

1. A polyalkylene polysulfide rubber composition comprising from 10 to 95% by weight of a polyalkylene polysulfide containing chains of the formula I
[[Sₓ—CRR′]]ₙ (I)
where
R and R′ are identical or different and are hydrogen or alkyl having from 1 to 4 carbon atoms or COR″, where
R″ is hydrogen or alkyl having from 1 to 4 carbon atoms,
x is a number whose average is from 2 to 20, and
n is a number>10, as component A,
from 0.1 to 20% by weight of a crosslinker, as component B,
from 0.1 to 90% by weight of fillers and/or pigments, as component C,
from 0 to 50% by weight of plasticizers, as component D, and
from 0 to 20% by weight of customary additives, such as adhesion promoters, agents with thixotropic effect, or accelerators, as component E.

2. A polyalkylene polysulfide rubber composition as claimed in claim 1, wherein the polyalkylene polysulfide consists essentially of chains of the formula I, and wherein x is a number whose average is from 2 to 5.

3. The use of a polyalkylene polysulfide rubber composition as defined in claim 1 or 2 as sealing material, coating material, impression material or as a molding composition for the manufacture of rubber items or films.

4. A process for preparing polyalkylene polysulfides by reacting at least one carbonyl compound of the formula II 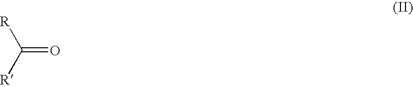
R and R′ are as defined above,
with sulfur and hydrogen sulfide in the presence of a basic catalyst.

5. A process as claimed in claim 4, wherein the molar ratio carbonyl compound:sulfur, based on sulfur atoms, is from 1:2 to 1:6.

6. A process as claimed in claim 4 or 5, wherein the basic catalyst has been selected from the group consisting of bases having sulfidic sulfur atoms, ammonia, amines and hydroxyl compounds.
